(19) United States
(12) Patent Application Publication
(10) Pub. No.: US 2007/0090709 A1
(43) Pub. Date: Apr. 26, 2007

(54) High-voltage transformer

(75) Inventor: Tomoyuki Kanno, Tokyo (JP)

Correspondence Address: SNIDER & ASSOCIATES, P. O. BOX 27613, WASHINGTON, DC, 20038-7613, US

(73) Assignee: Sumida Corporation, Tokyo (JP)

(21) Appl. No.: 10/576,306

(22) PCT Filed: Oct. 19, 2004
(86) PCT No.: PCT/JP04/15392

§ 371 Date: Apr. 19, 2006

(30) Foreign Application Priority Data
Oct. 20, 2003 (JP) 2003-359356

(51) Int. Cl. H02K 21/12

(52) U.S. Cl. 310/156.26

(57) ABSTRACT

This high-voltage transformer can regulate the leakage inductance accurately and easily. Winding frames of a primary-side winding (6), a secondary-side winding (7), and a magnetic-coupling adjusting winding (8) are provided so that the primary-side winding (6), the secondary-side winding (7), and magnetic-coupling adjusting winding (8) are placed in a common magnetic path. A part of either the primary-side winding (6) or the secondary-side winding (7) is wound around the frame of the magnetic-coupling adjusting winding (8). The frames of the primary-side winding (6) and the secondary-side winding (7) can be formed into a common frame, and the primary-side winding (6) and the secondary-side winding (7) can be wound superimposedly around the common winding frame. The frames of the primary-side winding (6) and the secondary-side winding (7) can be so provided on both sides of the frame of the magnetic-coupling adjusting winding (8) as to sandwich the frame of the magnetic-coupling adjusting winding (8).

### TECHNICAL FIELD

The present invention relates to a high-voltage transformer used for a high-voltage discharge lamp circuit.

### BACKGROUND ART

As a high-voltage transformer used for a high-voltage discharge lamp circuit, there is conventionally known a transformer whose leakage inductance is regulated by changing the coupling coefficient of a primary-side winding and a secondary-side winding, so as to be adapted to the rating of the high-voltage discharge lamp, a constant of a power supply circuit and the like.

There is known a method in which cores with different gap widths are used to regulate the leakage inductance by changing the coupling coefficient of the primary-side winding and the secondary-side winding. However, in this method, there is a problem that enormous kinds of cores are needed to make the leakage inductance adapted to high-voltage discharge lamps of various ratings and various power supply circuits of different constants, resulting in a cost increase.

In order to cope with such problem, there has been developed a high-voltage transformer which has a first magnetic path including a first winding part around which a part of a primary-side winding and a part of a secondary-side winding are wound, and a second magnetic path including a second winding part around which only the remaining part of the secondary-side winding is wound, so that the coupling coefficient of the transformer is arranged to be easily changed by adjusting the winding ratio of the secondary-side winding between the first winding part and the second winding part (see, for example, Patent Document 1).

Patent Document 1: Japanese Unexamined Patent Publication No. HEI 10-233325

### DISCLOSURE OF THE INVENTION

Problems to be Solved by the Invention

However, in the technique disclosed in the above described patent document 1, the magnetic path is divided into the first magnetic path and the second magnetic path, and the winding part for changing the coupling coefficient is provided in the second magnetic path, as a result of which an error may be caused in adjusting the leakage inductance, and there is also a case where a fine adjustment of the leakage inductance is difficult.

The present invention has been made in view of the above described circumstances. An object of the present invention is to provide a high-voltage transformer whose leakage inductance can be accurately and easily regulated.

Means for Solving the Problems

A high-voltage transformer according to the present invention, which is capable of achieving such object, is characterized in that frames of a primary-side winding, a secondary-side winding and a magnetic-coupling adjusting winding are arranged to make the primary-side winding, the secondary-side winding and the magnetic-coupling adjusting winding located in a common magnetic path, and that a part of one of the primary-side winding and the secondary-side winding is wound around the frame of the magnetic-coupling adjusting winding.

Further, in the high-voltage transformer according to the present invention, the frames of the primary-side winding and the secondary-side winding can be formed into a common frame, so as to make the primary-side winding and the secondary-side winding wound superimposedly around the common frame.

Further, in the high-voltage transformer according to the present invention, the frames of the primary-side winding and the secondary-side winding can be so provided on both sides of the frame of the magnetic-coupling adjusting winding as to sandwich the frame of the magnetic-coupling adjusting winding.

Further, in the high-voltage transformer according to the present invention, a part of the primary-side winding can be wound around the frame of the magnetic-coupling adjusting winding.

Further, in the high-voltage transformer according to the present invention, a part of the secondary-side winding can be wound around the frame of the magnetic-coupling adjusting winding.

Effect of the Invention

In the high-voltage transformer according to the present invention, the frames of the primary-side winding, the secondary-side winding and the magnetic-coupling adjusting winding are provided so as to make the primary-side winding, the secondary-side winding and the magnetic-coupling adjusting winding located in the common magnetic path. Thus, the leakage inductance can be adjusted correctly and easily by making all of the windings arranged in the common magnetic path, rather than by making the magnetic-coupling adjusting winding arranged in a magnetic path different from a magnetic path in which the primary-side winding and the secondary-side winding are arranged.

Further, the leakage inductance can be adjusted only by changing the number of turns of the magnetic-coupling adjusting winding, so that common components can be used to make the leakage inductance adapted to high-voltage discharge lamps of various ratings and to various power supply circuits of different constants.

Further, in the high-voltage transformer according to the present invention, the frames of the primary-side winding and the secondary-side winding are formed into a common frame, and the primary-side winding and the secondary-side winding are wound superimposedly around the common frame, so that the size of the transformer can be reduced as a whole, and the leakage inductance can be finely adjusted in the increasing direction by increasing the number of turns of the magnetic-coupling adjusting winding.

Further, in the high-voltage transformer according to the present invention, the frames of the primary-side winding and the secondary-side winding are provided on both sides of the frame of the magnetic-coupling adjusting winding so as to sandwich the frame of the magnetic-coupling adjusting winding, as a result of which the leakage inductance can be finely adjusted in the decreasing direction by increasing the number of turns of the magnetic-coupling adjusting winding.

Further, in the high-voltage transformer according to the present invention, the primary-side winding having the number of turns smaller than that of the secondary-side winding is used as the magnetic-coupling adjusting winding, so that the leakage inductance can be largely adjusted by changing the number of turns of the magnetic-coupling adjusting winding.

Further, in the high-voltage transformer according to the present invention, the secondary-side winding having the number of turns larger than that of the primary-side winding is used as the magnetic-coupling adjusting winding, so that the leakage inductance can be finely adjusted by changing the number of turns of the magnetic-coupling adjusting winding.

### BEST MODE FOR CARRYING OUT THE INVENTION

In the following, the high-voltage transformers according to embodiments of the present invention are explained in detail, with reference to the accompanying drawings.

### First Embodiment

FIG. 1 to FIG. 3 are figures showing a high-voltage transformer according to a first embodiment of the present invention. FIG. 1 is an exploded perspective view of the high-voltage transformer, FIG. 2 is a longitudinal sectional view of the high-voltage transformer, and FIG. 3 is a bottom view of a coil bobbin of the high-voltage transformer.

As shown in FIG. 1 and FIG. 2, the high-voltage transformer according to the first embodiment of the present invention, is formed in such a way that flanges 3a, 3b, 3c are provided for both ends of the outer peripheral surface of a coil bobbin 1 which has a lateral hollow part 2, and for a part near one of the both ends of the coil bobbin 1 (a part near left side end in an example shown in FIG. 1 to FIG. 3), respectively, that terminal supports 4 are provided for lower right and left sides of the coil bobbin 1, respectively, and that E-shaped cores 5 are mounted from the right and left sides of the coil bobbin 1.

The E-shaped cores 5 are made of, for example, ferrite. Central legs 5a of the E-shaped cores 5 are inserted into the hollow part 2 from the left and right of the coil bobbin 1, respectively, and both side legs 5b, 5c are positioned in the outside of the coil bobbin 1, so that the front faces of central legs 5a and the front faces of the both side legs 5b, 5c, which front faces are positioned on the left and right sides of the E-shaped cores, are respectively brought into tight contact with each other, so as to form a closed magnetic path.

Noted that in the present embodiment, the coil bobbin 1, the flanges 3a, 3b, 3c and the terminal support 4 are integrally molded with for example a synthetic resin and the like, which has the dielectric strength and the sufficient physical strength.

In this coil bobbin 1, a space between the right side flange 3c and the middle flange 3b serves as a frame 1a of a primary-side winding 6 and a secondary-side winding 7, and a space between the left side flange 3a and the middle flange 3b serves as a frame 1b of a magnetic-coupling adjusting winding 8.

As shown in FIG. 2, the primary-side winding 6 is first wound around the frame 1a of the primary-side winding 6 and the secondary-side winding 7, and then the secondary-side winding 7 is wound around the outer circumference of the primary-side winding 6 through the intermediary of an insulating member (not shown). Further, one of the primary-side winding 6 and the secondary-side winding 7 is extended to the frame 1b of the magnetic-coupling adjusting winding 8, and is wound around the frame 1b as the magnetic-coupling adjusting winding 8 for adjusting the leakage inductance.

Specifically, the secondary-side winding 7 whose number of turns of winding is larger than that of the primary-side winding 6 is preferably used as the magnetic-coupling adjusting winding 8, in order to finely adjust the leakage inductance. On the other hand, the primary-side winding 6 whose number of turns of winding is smaller than that of the secondary-side winding 7 is preferably used as the magnetic-coupling adjusting winding 8, in order to largely adjust the leakage inductance.

Although not shown in detail in the present embodiment, the primary-side winding 6 consists of two winding sections connected in parallel with each other, and the winding is wound, for example, for five turns in each of the winding sections. Also, the secondary-side winding 7 is wound, for example, for 100 turns. Further, the magnetic-coupling adjusting winding 8 is formed by extending the secondary-side winding 7 and is wound, for example, for 10 turns.

Terminals 9a, 9b, 9c, 9d and terminals 9a′, 9b′, 9c′, 9d′ of the primary-side winding 6 or the secondary-side winding 7 are provided for the lower surface on both right and left ends of the terminal support 4, respectively. In these terminals, the two sets of the terminals 9a, 9a′ and the terminals 9b, 9b′ are connected with both ends of each winding of the two winding sections which are connected in parallel with each other in the primary-side winding 6. Further, one of the two sets of the terminals 9c, 9c′ and the terminals 9d, 9d′ is connected with both ends of the secondary-side winding 7.

As shown in FIG. 3, a notch part 10 for making the coil bobbin 1 communicated to right and left is provided for the lower surface of the middle flange 3b. The secondary-side winding 7 or the primary-side winding 6 is extended through the notch part 10, so as to be wound around the frame 1b of the magnetic-coupling adjusting winding 8.

In the high-voltage transformer according to the present embodiment, the leakage inductance can be finely adjusted in the increasing direction by increasing the number of turns of the magnetic-coupling adjusting winding 8.

### Second Embodiment

FIG. 4 to FIG. 6 are figures showing a second embodiment of a high-voltage transformer according to the present invention. FIG. 4 is an exploded perspective view of the high-voltage transformer, FIG. 5 is a longitudinal sectional view of the high-voltage transformer, and FIG. 6 is a bottom view of the coil bobbin of the high-voltage transformer.

As shown in FIG. 4 and FIG. 5, the high-voltage transformer according to the second embodiment of the present invention, is formed in such a way that flanges 23a, 23d are provided for both ends of the outer peripheral surface of a coil bobbin 21 having a lateral hollow part 22, respectively, that a pair of right and left flanges 23b, 23c are provided for the central part of the coil bobbin 21, that terminal supports 24 are provided for lower right and left sides of the coil bobbin 21, respectively, and that E-shaped cores 25 are mounted from the right and left sides of the coil bobbin 21.

The E-shaped core 25 is configured similarly to that according to the above described first embodiment. Noted that in FIG. 4, reference character 25a denotes a central leg, and 25b, 25c denote both side legs, respectively.

In the coil bobbin 21, a space between the left end flange 23a and the central left side flange 23b and a space between the right end flange 23d and the central right side flange 23c serve as a frame 21a of a primary-side winding 26 or a frame 21c of a secondary-side winding 27, respectively. A space between a pair of the central flanges 23b, 23c serves as a frame 21b of a magnetic-coupling adjusting winding 28.

The primary-side winding 26 or the secondary-side winding 27 is wound around the frames 21a, 21c of the primary-side winding 26 and the secondary-side winding 27, respectively. Further, one of the primary-side winding 26 and the secondary-side winding 27 is extended and wound around the frame 21b of the magnetic-coupling adjusting winding 28.

Specifically, the secondary-side winding 27 whose number of turns of winding is larger than that of the primary-side winding 26 is preferably used as the magnetic-coupling adjusting winding 28, in order to finely adjust the leakage inductance. On the other hand, the primary-side winding 26 whose number of turns of winding is smaller than that of the secondary-side winding 27 is preferably used as the magnetic-coupling adjusting winding 28, in order to largely adjust the leakage inductance.

Although not shown in detail in the present embodiment, the primary-side winding 26 consists of two winding sections connected in parallel with each other, and the winding in each of the winding sections is wound, for example, for five turns. Also, the secondary-side winding 27 is wound, for example, for 100 turns. Further, the magnetic-coupling adjusting winding 28 is formed by extending the secondary-side winding 27, so as to be wound, for example, for 10 turns.

Terminals 29a, 29b, 29c, 29d and terminals 29a′, 29b′, 29c′, 29d′ of the primary-side winding 26 or the secondary-side winding 27 are provided for the lower surfaces of both right and left ends of the terminal support 24, respectively. The configuration and the connection form of the terminals 29a, 29b, 29c, 29d and the terminals 29a′, 29b′, 29c′, 29d′ are the same as those according to the first embodiment.

As shown in FIG. 6, a notch part 30 for making the coil bobbin 21 communicated to left and right is provided for the lower surfaces of the central flanges 23b, 23c. The secondary-side winding 27 or the primary-side winding 26 is extended through this notch part 30, so as to be wound around the frame 21b of the magnetic-coupling adjusting winding 28.

In the high-voltage transformer according to the present embodiment, the leakage inductance can be finely adjusted in the decreasing direction by increasing the number of turns of the magnetic-coupling adjusting winding 28.

### Another Embodiment

The high-voltage transformer according to the present invention is preferably used in particular for the high-voltage discharge lamp circuit, but can also be applied to other various kinds of transformers, in which the leakage inductance needs to be regulated by changing the coupling coefficient between the primary-side winding and the secondary-side winding.

Further, the core used for the high-voltage transformer is preferably made of ferrite, but other material such as permalloy, sendust and iron carbonyl can be used for the core. A dust core obtained by compressing and molding of fine powder of these materials can also be used as the core.

Further, in each of the embodiments, the core part is formed by joining two E-shaped cores, but the core part may be formed by combining an I-shaped core with a U-shaped core.

Further, the number of division of the primary-side winding is not restricted to two, but may be three or more. The primary-side winding may not be divided. Further, the numbers of turns of the primary-side winding, the secondary-side winding and the magnetic-coupling adjusting winding can be suitably changed and implemented, so as to make them adapted to the rating of the high-voltage discharge lamp and the constant of the power supply circuit, and the like, which use the high-voltage transformer according to the present invention.

### BRIEF DESCRIPTION OF THE DRAWINGS

FIG. 1 is an exploded perspective view of a high-voltage transformer according to a first embodiment of the present invention;

FIG. 2 is a longitudinal sectional view of the high-voltage transformer according to the first embodiment of the present invention;

FIG. 3 is a bottom view of a coil bobbin of the high-voltage transformer according to the first embodiment of the present invention;

FIG. 4 is an exploded perspective view of a high-voltage transformer according to a second embodiment of the present invention;

FIG. 5 is a longitudinal sectional view of the high-voltage transformer according to the second embodiment of the present invention; and

FIG. 6 is a bottom view of a coil bobbin of the high-voltage transformer according to the second embodiment of the present invention.

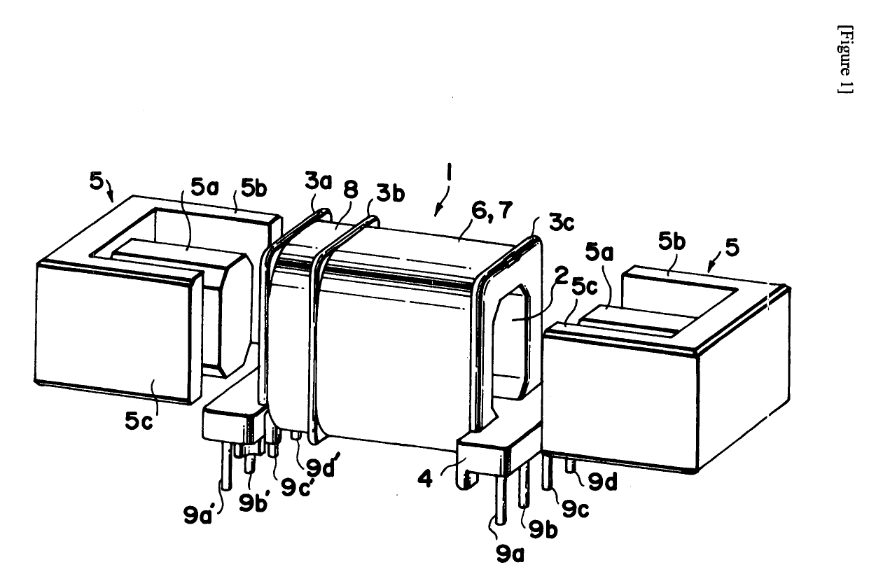

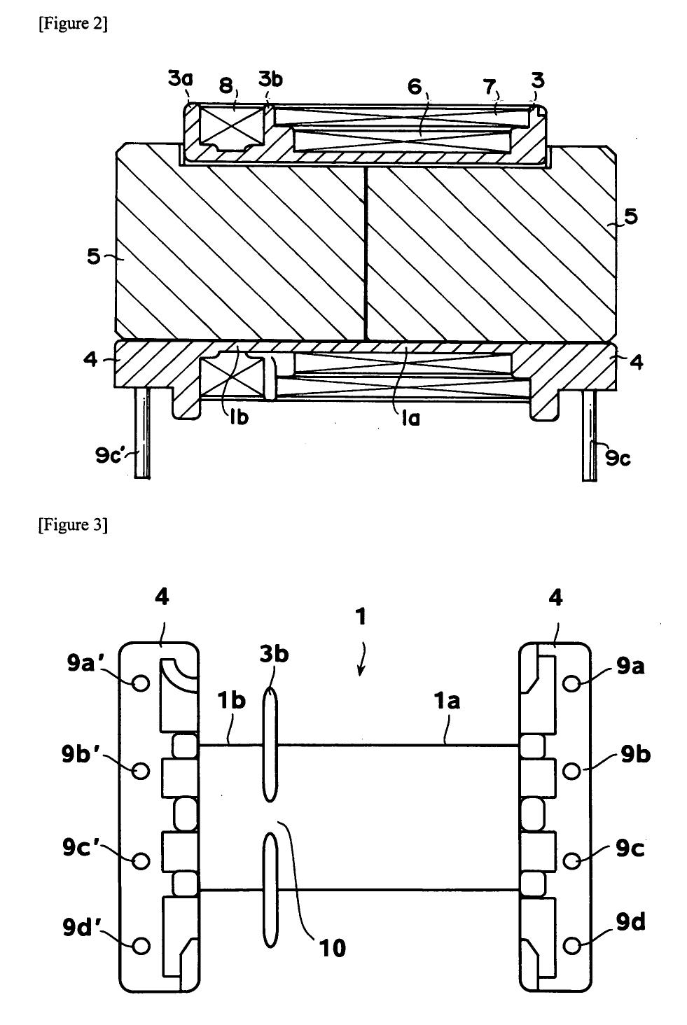

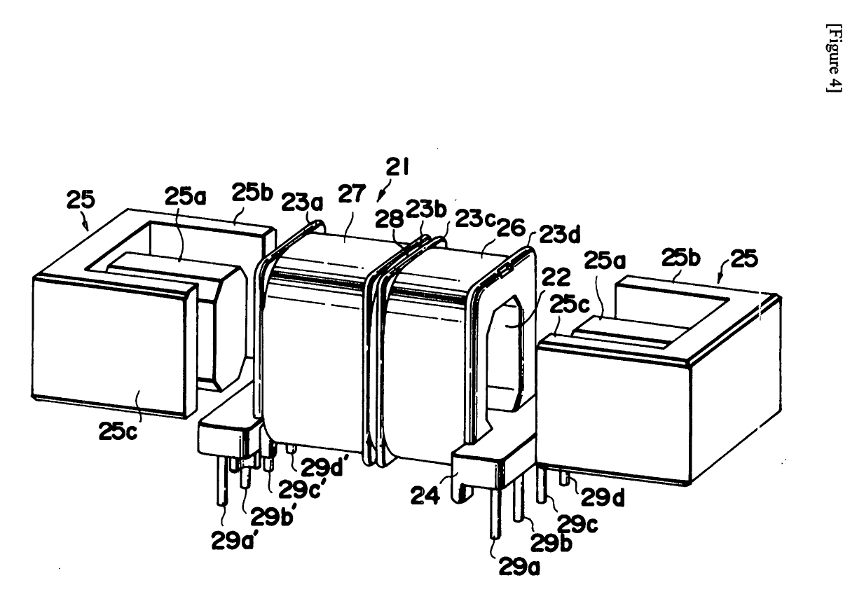

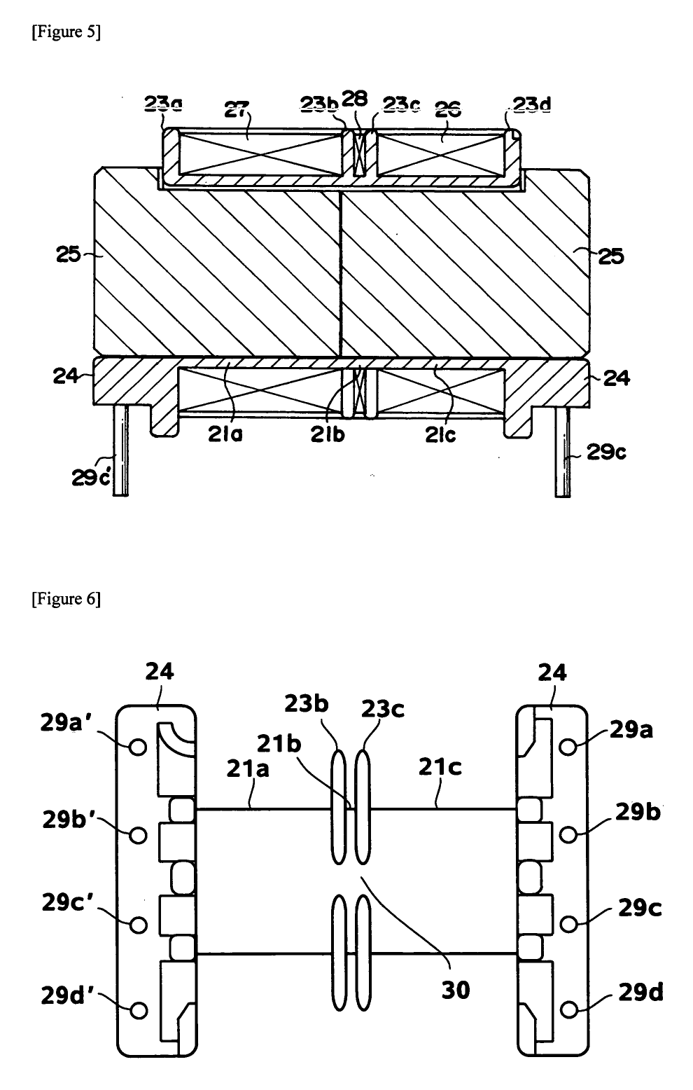

### DESCRIPTION OF SYMBOLS

1, 21 Coil bobbin
1a Frame of primary-side winding and secondary-side winding
1b, 21b Frame of magnetic-coupling adjusting winding
21a, 21c Frame of primary-side winding, Frame of secondary-side winding
2, 22 Hollow part
3a to 3c, 23a to 23d Flange
4, 24 Terminal support
5, 25 E-shaped core
5a, 25a Central leg
5b, 5c, 25b, 25c Both side legs
6, 26 Primary-side winding
7, 27 Secondary-side winding
8, 28 Magnetic-coupling adjusting winding
9a to 9d, 9a′ to 9d′, 29a to 29d, 29a′ to 29d′ Terminals
10, 30 Notch part

1. A high-voltage transformer provided with a bobbin in which frames of a primary-side winding and a secondary-side winding are provided on both sides of a frame of a magnetic-coupling adjusting winding to sandwich the frame of the magnetic-coupling adjusting winding, in order to make the frames of the primary-side winding, the secondary-side winding and the magnetic-coupling adjusting winding located in the same magnetic path,
wherein a first flange part is provided between the frame of the primary-side winding and the frame of the magnetic-coupling adjusting winding, and a second flange part is provided between the frame of the secondary-side winding and the frame of the magnetic-coupling adjusting winding, and
wherein a part of one of the primary-side winding and the secondary-side winding is wound around the frame of the magnetic-coupling adjusting winding through a notch part which is formed in the first flange part or the second flange part located on the lower surface side of the bobbin.

2-3. (canceled)

4. The high-voltage transformer according to claim 1, wherein a part of the primary-side winding is wound around the frame of the magnetic-coupling adjusting winding to largely adjust the leakage inductance.

5. The high-voltage transformer according to claim 1, wherein a part of the secondary-side winding is wound around the frame of the magnetic-coupling adjusting winding to finely adjust the leakage inductance.

6. The high-voltage transformer according to claim 1, wherein pin-shaped terminals for substrate connection are provided for the bobbin, pin-shaped terminals extend in one direction substantially orthogonal to a direction in which the frames of the primary-side winding, the magnetic-coupling adjusting winding, and the secondary-side winding are arranged.
